(19) United States
(12) Patent Application Publication
(10) Pub. No.: US 2025/0296030 A1
(43) Pub. Date: Sep. 25, 2025

(54) ELECTROCHEMICAL HYDROGEN COMPRESSION SYSTEM

(71) Applicant: HONDA MOTOR CO., LTD., TOKYO (JP)

(72) Inventor: Yuta HOSHI, WAKO-SHI (JP)

(21) Appl. No.: 19/066,929

(22) Filed: Feb. 28, 2025

(30) Foreign Application Priority Data
Mar. 21, 2024 (JP) 2024-045127

(51) Int. Cl. B01D 53/04; B01D 53/047; B01D 53/26

(52) U.S. Cl. CPC B01D 53/0446; B01D 53/0423; B01D 53/047; B01D 53/261; B01D 2256/16; B01D 2257/80

(57) ABSTRACT

The electrochemical hydrogen compression system includes: a hydrogen compression stack for compressing hydrogen gas supplied to an anode and discharging from a cathode through an electrolyte membrane compressed, high-pressure hydrogen gas; a hydrogen supply device for supplying the hydrogen gas to the anode of the hydrogen compression stack through a hydrogen supply flow path, and a pressure swing adsorption device having a plurality of adsorption towers for dehumidifying the high-pressure hydrogen gas discharged from the hydrogen compression stack; and a return flow path configured to return the hydrogen gas for recovery used for recovery of the adsorption towers to the hydrogen supply flow path or the hydrogen supply device.

### CROSS-REFERENCE TO RELATED APPLICATIONS

This application is based upon and claims the benefit of priority from Japanese Patent Application No. 2024-045127 filed on Mar. 21, 2024, the contents of which are incorporated herein by reference.

### BACKGROUND OF THE INVENTION

### Field of the Invention

The present disclosure relates to an electrochemical hydrogen compression system.

### Description of the Related Art

In recent years, in order to make it possible for more people to be capable of relying thereon at an affordable cost, and to ensure access to sustainable and advanced energy, research and development have been conducted in relation to an electrochemical hydrogen compression system that contributes to energy efficiency.

JP 2022-094891 A discloses an electrochemical hydrogen compression system for compressing hydrogen gas. The electrochemical hydrogen compression system includes an electrochemical hydrogen compression device. The electrochemical hydrogen compression device has a unit cell formed of a proton exchange membrane (electrolyte membrane) and an anode and a cathode provided on both sides of the proton exchange membrane, and applies a current between the anode and the cathode to compress hydrogen gas supplied to the anode and produce high-pressure hydrogen gas at the cathode.

JP 2009-291732 A discloses a pressure swing adsorption (PSA) type dehumidifier which obtains low dew-point air by pressure swing adsorption. This PSA type dehumidifier alternately performs a processing step of passing treatment air through an adsorbent vessel containing an adsorbent and a recovery step of passing recovery air through the adsorbent vessel, and obtains low dew point air by pressure swing adsorption.

### SUMMARY OF THE INVENTION

The high-pressure hydrogen gas generated by the electrochemical hydrogen compression system contains a large amount of water. Therefore, for example, in order to supply the hydrogen gas to a hydrogen tank of a fuel cell system mounted on a moving object such as a vehicle, it is necessary to remove water contained in the hydrogen gas. In this case, it is conceivable to remove water contained in the hydrogen gas by a pressure swing adsorption (PSA) device.

The PSA device has at least two adsorption towers containing adsorbents. When the amount of water adsorbed in one adsorption tower reaches an upper limit value, the PSA device switches to the other adsorption tower to continue removal of water, and at the same time, hydrogen gas for recovery is caused to flow in the one adsorption tower to release the adsorbed water. Such hydrogen gas that has been used for recovery is not suitable for use in a fuel cell system because it contains a large amount of water, and therefore there is a problem that the hydrogen production efficiency of the electrochemical hydrogen compression system is reduced.

The present invention has the object of solving the aforementioned problem.

A first aspect of the present disclosure is characterized by an electrochemical hydrogen compression system, comprising a hydrogen compression stack having a unit cell including an electrolyte membrane, an anode disposed on one surface of the electrolyte membrane, and a cathode disposed on another surface of the electrolyte membrane, and configured to be supplied with a hydrogen gas at the anode, and to discharge from the cathode a hydrogen gas which has been compressed, an electrical power source device configured to apply a voltage to the hydrogen compression stack, a hydrogen supply device configured to supply the hydrogen gas to the hydrogen compression stack via a hydrogen supply flow path, a pressure swing adsorption device including a plurality of adsorption towers configured to dehumidify the hydrogen gas which has been compressed discharged from the hydrogen compression stack, and a return and flow path configured to return a hydrogen gas which has been used for recovery of the adsorption towers to the hydrogen supply flow path of the hydrogen compression stack or to the hydrogen supply device.

According to the above aspect, the hydrogen gas used for recovery is returned to the hydrogen supply flow path of the hydrogen compression stack or the hydrogen supply device through the return flow path, and thus the hydrogen gas used for recovery can be used without being wasted in vain, instead of being discharged to the exterior. Accordingly, it is possible to suppress a decrease in the hydrogen production efficiency of the electrochemical hydrogen compression system.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic configuration diagram of an electrochemical hydrogen compression system according to an embodiment;

FIG. 2A is an explanatory view relating to an adsorption step carried out by an adsorption tower A of a pressure swing adsorption (PSA) device;

FIG. 2B is an explanatory view of an adsorption step carried out by an adsorption tower B of the PSA device;

FIG. 2C is an explanatory view of a recovery step carried out by the adsorption tower A of the PSA device;

FIG. 2D is an explanatory view of a recovery step carried out by the adsorption tower B of the PSA device;

FIG. 3 is a flowchart of the adsorption step and the recovery step of the PSA device;

FIG. 4 is a flowchart of the adsorption step and the recovery step of the PSA device continued from FIG. 3;

FIG. 5 is a timing chart relating to the respective steps of the adsorption tower A and the adsorption tower B and raw material hydrogen supply.

### DETAILED DESCRIPTION OF THE INVENTION

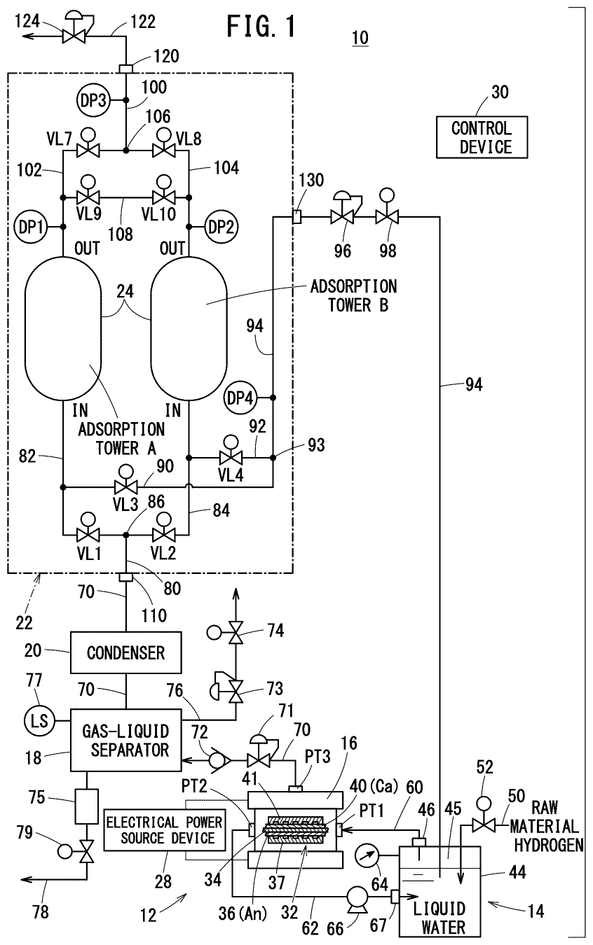

FIG. 1 is a schematic diagram showing an electrochemical hydrogen compression system 10 according to an embodiment. The electrochemical hydrogen compression system 10 is equipped with an electrochemical hydrogen compression device 12, a hydrogen supply device 14, a gas-liquid separator 18, a condenser 20, a pressure swing adsorption (PSA) device 22, and a control device 30.

The electrochemical hydrogen compression device 12 is a device that electrochemically compresses a hydrogen gas. The electrochemical hydrogen compression device 12 is equipped with a hydrogen compression stack 16, and an electrical power source device 28 that applies a voltage to the hydrogen compression stack 16.

The hydrogen compression stack 16 includes a hydrogen inlet PT1, a hydrogen outlet PT2, and a high pressure hydrogen outlet PT3. The hydrogen inlet PT1 introduces the hydrogen gas supplied from the hydrogen supply device 14 into the hydrogen compression stack 16. The introduced hydrogen gas communicates with the anode 36 of each of the unit cells 32. The hydrogen outlet PT2 discharges the unused hydrogen gas. The high pressure hydrogen outlet PT3 discharges high pressure hydrogen gas that is generated in each of the unit cells 32. The high pressure hydrogen gas communicates with the cathode 40 of each of the unit cells 32.

The hydrogen compression stack 16 is constituted by stacking a plurality of the unit cells 32. All of the plurality of unit cells 32 have the same structure. Each of the unit cells 32 includes an electrolyte membrane 34, the anode 36 provided on one surface of the electrolyte membrane 34, an anode current collector 37, the cathode 40 provided on another surface of the electrolyte membrane 34, and a cathode current collector 41.

As the electrolyte membrane 34, there is employed, for example, a solid polymer electrolyte membrane (cation ion exchange membrane). The electrolyte membrane 34 may be reinforced on the anode side thereof with a protective sheet (not shown) containing a fibrous skeletal framework. In accordance with this feature, it is possible to withstand the pressure of the high pressure hydrogen gas applied from the side of the cathode. Further, for the electrolyte membrane 34, an HC (hydrocarbon) electrolyte can be used in addition to a fluorine electrolyte. The electrolyte membrane 34 is sandwiched between the anode 36 and the cathode 40.

The anode 36 includes an anode catalyst layer bonded to the one surface of the electrolyte membrane 34. The anode current collector 37 is stacked on the anode catalyst layer. The anode catalyst layer includes a platinum-based catalyst. An anode flow path through which hydrogen gas flows is formed in the anode current collector 37. The hydrogen gas introduced from the hydrogen inlet PT1 flows through the anode flow path and arrives at the anode catalyst layer. A porous reinforcing plate may be interposed between the anode catalyst layer and the anode current collector 37. The reinforcing plate is capable of effectively withstanding the pressure of the high pressure hydrogen gas that is applied from the side of the cathode.

The cathode 40 includes a cathode catalyst layer bonded to the other surface of the electrolyte membrane 34. The cathode current collector 41 is stacked on the cathode catalyst layer. The cathode catalyst layer includes a platinum-based catalyst. A cathode flow path through which pressurized high pressure hydrogen gas flows is formed in the cathode current collector 41. The high pressure hydrogen gas flows through the cathode flow path and is discharged from a high pressure hydrogen outlet PT3.

When a voltage is applied between the anode 36 and the cathode 40, the hydrogen gas supplied from the hydrogen inlet PT1 to the anode 36 is ionized into protons (hydrogen ions) and electrons by a catalytic reaction in the anode catalyst layer. The generated protons permeate through the electrolyte membrane 34 and move to the cathode 40. At this time, the protons accompany water to the cathode 40. Therefore, the hydrogen gas supplied to the anode 36 needs to be humidified. At the cathode 40, the protons that have permeated through the electrolyte membrane 34 combine with the electrons, and thereby generate the high pressure hydrogen gas by way of an electrochemical reaction. Unused hydrogen gas that has not been ionized at the anode 36 is discharged from the hydrogen outlet PT2. The pressure of the high pressure hydrogen gas that flows through the cathode flow path is higher than the pressure of the hydrogen gas that flows through the anode flow path.

The electrical power source device 28 applies a DC voltage to the hydrogen compression stack 16. In accordance therewith, the electrical current flows to the hydrogen compression stack 16. The hydrogen compression stack 16 includes a stacked body in which a plurality of the unit cells 32 are stacked, and an anode connection terminal and a cathode connection terminal (both not shown) disposed respectively on both ends of the stack. A positive electrode of the electrical power source device 28 is connected via a connection cable to the anode connection terminal, and a negative electrode of the electrical power source device 28 is connected via a connection cable to the cathode connection terminal. Thus, a positive potential is applied to the anode 36 of each unit cell 32, and a negative potential is applied to the cathode 40 of each unit cell 32.

The electrical power source device 28, in response to a control command from the control device 30, is capable of adjusting the size of the voltage applied to the hydrogen compression stack 16. The voltage supplied to the hydrogen compression stack 16 is applied equally to each of the unit cells 32. As the voltage supplied to the hydrogen compression stack 16 becomes greater, the greater becomes the current that flows, and the greater becomes the amount of the high pressure hydrogen gas that is generated in the hydrogen compression stack 16.

The hydrogen supply device 14 includes a sealed container 44 in which the liquid water is stored downwardly in the direction of gravity. The raw material hydrogen is supplied via a raw material hydrogen supply path 50 into the liquid water of the sealed container 44. A raw material hydrogen valve 52 is provided in the raw material hydrogen supply path 50. The raw material hydrogen valve 52 causes the raw material hydrogen to flow by being opened, and the flow of the raw material hydrogen stops by being closed.

An opening is formed at one end of the raw material hydrogen supply path 50, and this opening opens within the liquid water in the sealed container 44, and the raw material hydrogen flows out from the opening as hydrogen gas, turns into gas bubbles inside the liquid water, and rises upwardly of the sealed container 44. At this time, the liquid droplets contained in the raw material hydrogen are taken into the liquid water. Further, the hydrogen gas that has risen upwardly of the liquid water is humidified by the liquid water. The sealed container 44 includes both a function as a gas-liquid separator 18 and a function as a humidifier.

The raw material hydrogen may contain hydrogen gas, and may be generated, for example, by the electrolysis of water. Alternatively, the raw material hydrogen may be generated by a reforming reaction from a raw material containing hydrocarbons. The raw material hydrogen may contain conductive components therein such as potassium hydroxide contained in the electrolyte when the water is subjected to electrolysis, and impurities other than the hydrogen gas that are generated during the reforming reaction. These impurities are removed in the hydrogen compression stack 16, and are not contained within the high pressure hydrogen gas that is generated.

Upwardly of the liquid water that is stored in the sealed container 44, a space 45 is formed in which there is collected the hydrogen gas that has passed through the liquid water and has been humidified. The hydrogen gas which is contained in the interior of the space 45 is pressurized to a predetermined pressure. A pressure sensor 64, which communicates with the space 45, and measures the pressure of the hydrogen gas contained in the space 45, is provided in the sealed container 44. Further, a hydrogen outlet 46, which communicates with the space 45 and through which the hydrogen gas is discharged, is provided upwardly of the sealed container 44. The hydrogen gas that has been pressurized to the predetermined pressure is discharged from the hydrogen outlet 46.

The hydrogen outlet 46 communicates via a hydrogen supply flow path 60 with the hydrogen inlet PT1 of the hydrogen compression stack 16. The hydrogen outlet PT2 of the hydrogen compression stack 16 is connected to a hydrogen circulation inlet 67 of the sealed container 44 via a hydrogen circulation flow path 62. The hydrogen circulation inlet 67 communicates with the liquid water of the sealed container 44. The unused hydrogen gas in the hydrogen compression stack 16 is circulated to the hermetically sealed container 44. A circulation pump 66 for causing the hydrogen gas to be circulated is provided in the hydrogen circulation flow path 62.

The high pressure hydrogen outlet PT3 of the hydrogen compression stack 16 is connected to, via a high pressure hydrogen supply flow path 70, an introduction path 80 of the PSA device 22. In the high pressure hydrogen supply flow path 70, a back pressure valve 71, a check valve 72, the gas-liquid separator 18 and the condenser 20 are provided in this order from an upstream side. Moreover, the condenser 20 may be provided in accordance with the specifications required for the high pressure hydrogen gas, and need not necessarily be provided.

The back pressure valve 71 adjusts the pressure of the high pressure hydrogen gas output from the hydrogen compression stack 16. The check valve 72 allows the high pressure hydrogen gas to flow from the hydrogen compression stack 16 to the gas-liquid separator 18, and prevents the high pressure hydrogen gas from flowing back from the gas-liquid separator 18 to the hydrogen compression stack 16.

The gas-liquid separator 18 removes the liquid component (liquid droplets) contained in the high pressure hydrogen gas as liquid water. The gas-liquid separator 18 supplies, to the PSA device 22 provided on the downstream side, the high pressure hydrogen gas from which the liquid water has been removed. The gas-liquid separator 18 is constituted by a sealed container. A level switch 77, which measures the amount of the liquid water that is stored, is provided in the interior of the gas-liquid separator 18. The level switch 77 measures the height of the liquid surface (an upper surface of the liquid water) that is stored in the interior of the sealed container.

A drain flow path 78, which discharges the separated liquid water to the exterior, is connected downwardly of the gas-liquid separator 18 in the direction of gravity. A throttle valve 75 and an opening/closing valve 79 are provided in the drain flow path 78 sequentially in this order from the upstream side. The throttle valve 75 adjusts the flow amount of the liquid water that flows through the drain flow path 78. The opening/closing valve 79, by being opened, discharges the liquid water from the drain flow path 78, and by being closed, stops the discharging of the liquid water. When the control device 30, by means of a signal from the level switch 77, detects that the liquid water that is stored in the interior of the gas-liquid separator 18 exceeds an upper limit value, the opening/closing valve 79 opens, and releases the liquid water to the exterior.

A relief flow path 76 in communication with the internal high pressure hydrogen gas is formed upwardly of the gas-liquid separator 18 in the direction of gravity. The relief flow path 76 is provided with a pressure reducing valve 73 and a flow amount adjusting valve 74 in order from the upstream side. In the relief flow path 76, the pressure in the flow path connected to the hydrogen compression stack 16 is released by adjusting and operating the pressure reducing valve 73 and the flow amount adjusting valve 74. The pressure reducing valve 73 reduces and adjusts the pressure of the high pressure hydrogen gas flowing through the relief flow path 76 to a pressure suitable for depressurization. The flow amount adjusting valve 74 adjusts the flow rate of the high pressure hydrogen gas flowing through the relief flow path 76, and stops the release of the hydrogen gas by closing the valve.

The condenser 20 is provided between the gas-liquid separator 18 and the PSA device 22. The condenser 20 cools the high pressure hydrogen gas by carrying out heat exchange with the flowing high pressure hydrogen gas. In accordance with this feature, the water vapor contained in the high pressure hydrogen gas is condensed, and thereby causes the humidity of the high pressure hydrogen gas to be reduced.

### PSA Device

The PSA device 22 shown in FIG. 1 will be described.

The PSA device 22 according to the present embodiment includes a plurality of adsorption towers 24 (adsorption tower A and adsorption tower B). The plurality of adsorption towers 24 are alternately switched, and thereby adsorb by means of an adsorbents the water contained in the introduced hydrogen gas, and output a dried hydrogen gas. When the amount of water adsorbed has reached an upper limit value, the adsorbed water is released by passing dried hydrogen gas through the adsorption towers 24, and the adsorbent is brought back into the reusable condition. The PSA device 22 includes a hydrogen inlet 110 through which hydrogen gas is introduced and a hydrogen outlet 120 through which hydrogen gas is output.

Each of adsorption towers 24 of the PSA device 22 is filled with a porous adsorbent such as activated carbon, zeolite, alumina, or silica or the like. The adsorption tower 24 is constituted by a cylindrical adsorption vessel. The adsorption vessel is installed with the axis of the cylinder extending along the direction of gravity. The adsorption vessel may be arranged with the axis extending along the horizontal direction. In the present embodiment, the PSA device 22 having two adsorption towers 24 (adsorption tower A and adsorption tower B) will be described. However, the number of adsorption towers 24 is not limited to two, and may be three or more but not one.

Gas inlets (IN) are provided at the lower ends of the adsorption towers 24. The hydrogen gas containing water and supplied from the gas inlets is discharged from the gas outlets (OUT) after water is removed by the adsorbents filled in the adsorption towers 24. The gas outlets are provided at the upper ends of the adsorption towers 24. When the water content of the adsorbent of the adsorption tower 24 reaches the upper limit value, the ability of the adsorbent to adsorb water is reduced, and therefore, the adsorbent needs to recover the lost function by releasing water.

The plurality of adsorption towers 24 include a processing adsorption tower that performs an adsorption process by adsorbing water contained in the hydrogen gas and a recovering adsorption tower that performs a recovery process by releasing the water adsorbed by the adsorbent. In the recovery process, hydrogen gas dehumidified and dried in the adsorption process of the other adsorption tower 24 is used. However, a hydrogen storage device in which dry hydrogen gas is stored may be provided inside the electrochemical hydrogen compression system 10, and dried hydrogen gas may be supplied from this hydrogen storage device. The plurality of adsorption towers 24 alternately perform the adsorption process and the recovery process.

The plurality of adsorption towers 24 includes at least one processing adsorption tower and at least one recovering adsorption tower. The adsorption towers 24 may include two or more adsorption towers as either the processing adsorption tower or the recovering adsorption tower. The hydrogen gas (hydrogen gas for recovery) used for recovery of the recovering adsorption tower contains water and is discharged from a dedicated outlet 130 of the PSA device 22 to hydrogen for recovery. The plurality of adsorption towers 24 are configured to have the same specifications. However, the adsorption towers 24 may have different specifications.

The hydrogen inlet 110 of the PSA device 22 communicates via the high pressure hydrogen supply flow path 70 with the high pressure hydrogen outlet PT3 of the hydrogen compression stack 16. The hydrogen outlet 120 of the PSA device 22 communicates with a hydrogen tank or the like (not shown) via a high pressure hydrogen lead-out path 122. The high pressure hydrogen lead-out path 122 is provided with a back pressure valve 124 to adjust the pressure of the high pressure hydrogen gas to be led out. The high pressure hydrogen lead-out path 122 is provided with an opening/closing valve (not shown), and the high pressure hydrogen gas is supplied by opening the valve, and the supply of the high-pressure hydrogen gas is stopped by closing the valve. A coupler or the like that is capable of releasing the disconnection of the hydrogen tank may be provided between the high pressure hydrogen lead-out path 122 and the hydrogen tank. The hydrogen tank is installed in a mobile vehicle that is equipped with a fuel cell system, industrial equipment, a stationary electrical power generation equipment, or the like. The high pressure hydrogen lead-out path 122 may be directly connected to a fuel cell system that does not include a hydrogen tank. The outlet 130 of the PSA device 22 dedicated to hydrogen for recovery communicates with the sealed container 44 of the hydrogen supply device 14 via the return flow path 94. Therefore, the hydrogen gas used for recovery of the recovering adsorption tower (hydrogen gas for recovery) is returned to the sealed container 44.

The return flow path 94 may be connected to the high pressure hydrogen supply flow path 70 that connects the gas-liquid separator 18 and the hydrogen compression stack 16. In this case, the return flow path 94 is connected to the hydrogen inlet PT1 of the hydrogen compression stack 16. That is, the hydrogen gas for recovery discharged from the outlet 130 dedicated to hydrogen for recovery is returned to the devices on the upstream side of the hydrogen compression stack 16 via the return flow path 94.

The end part on the downstream side of the return flow path 94 includes a hydrogen release hole. The hydrogen release hole opens into the space 45 on an upper part of the sealed container 44. The hydrogen release hole may open into the liquid water of the sealed container 44. In accordance with this feature, water droplets are removed from the hydrogen gas for recovery that is released from the hydrogen release hole within the liquid water, and the hydrogen gas is satisfactorily humidified prior to reaching the space 45 on the upper side, and is supplied via the hydrogen supply flow path 60 to the hydrogen compression stack 16.

The return flow path 94 is provided with a pressure reducing valve 96 and a flow amount adjusting valve 98. The pressure reducing valve 96 reduces the pressure of the hydrogen gas for recovery discharged from the PSA device 22. The hydrogen gas for recovery having been decompressed flows to the downstream side. The flow amount adjusting valve 98 adjusts the flow amount of the hydrogen gas for recovery discharged from the PSA device 22. The flow amount adjusting valve 98 adjusts the flow amount of the hydrogen gas for recovery to be supplied in accordance with the pressure in the space 45 above the liquid water in the sealed container 44.

That is, when the flow amount of the hydrogen gas supplied from the space 45 of the sealed container 44 to the hydrogen compression stack 16 via the hydrogen supply flow path 60 increases, the pressure in the space 45 inside the sealed container 44 detected by the pressure sensor 64 decreases. Therefore, the control device 30 adjusts the flow amount adjusting valve 98 so as to increase the flow amount of the hydrogen gas for recovery supplied to the sealed container 44 through the return flow path 94, so that the pressure in the space 45 inside the sealed container 44 is maintained at a predetermined value. While the hydrogen gas for recovery is supplied to the sealed container 44 via the return flow path 94, the raw material hydrogen is not supplied to the sealed container 44. More specifically, the raw material hydrogen valve 52 that is provided in the raw material hydrogen supply path 50 is closed. The pressure of the hydrogen gas for recovery supplied from the return flow path 94 is lower than the pressure of the raw material hydrogen.

The PSA device 22 includes, in addition to the plurality of adsorption towers 24, a plurality of opening/closing valves VL1 to VL10 that control the flow of the hydrogen gas to the adsorption towers 24 based on a command from the control device 30, and a plurality of connection flow paths connected to the opening/closing valves VL1 to VL10. In the following description, the opening/closing valves VL1 to VL10 are also simply referred to as VL1 to VL10. Note that VL5 and VL6 are missing numbers.

The introduction path 80 connected to the hydrogen inlet 110 of the PSA device 22 is branched into a first supply flow path 82 and a second supply flow path 84 at a branch point 86. The first supply flow path 82 and the second supply flow path 84 are connected to the gas inlet of the adsorption tower A and the gas inlet of the adsorption tower B, respectively. The first supply flow path 82 and the second supply flow path 84 are provided with the opening/closing valve VL1 and the opening/closing valve VL2, respectively, to control the flow of the hydrogen gas in the first supply flow path 82 and the second supply flow path 84.

At a position downstream of the opening/closing valve VL1, the first supply flow path 82 is connected to a first discharge flow path 90 connected to the outlet 130 dedicated to hydrogen for recovery. The first discharge flow path 90 is provided with the opening/closing valve VL3 for controlling the flow of the hydrogen gas for recovery in the first discharge flow path 90. At a position downstream of the opening/closing valve VL2, the second supply flow path 84 is connected to a second discharging flow path 92 connected to the outlet 130 dedicated to hydrogen for recovery. The second discharge flow path 92 is provided with the opening/closing valve VL4 for controlling the flow of the hydrogen gas for recovery in the second discharge flow path 92.

The first discharge flow path 90 and the second discharge flow path 92 merge at a downstream merging point 93 and are connected to the outlet 130 dedicated to hydrogen for recovery.

A first release flow path 102 and a second release flow path 104 are connected to a gas outlet of the adsorption tower A and a gas outlet of the adsorption tower B, respectively. The first release flow path 102 and the second release flow path 104 merge at a merging point 106 and are connected to the hydrogen outlet 120 via an outlet path 100. The first release flow path 102 and the second release flow path 104 are provided with opening/closing valves VL7 and VL8, respectively, to control the flow of the hydrogen gas in the first release flow path 102 and the second release flow path 104.

The first release flow path 102 upstream of the VL7 and the second release flow path 104 upstream of the VL8 are connected to each other through an outlet bypass flow path 108. The outlet bypass flow path 108 is provided with the opening/closing valve VL9 and the opening/closing valve VL10 to control the flow of the hydrogen gas in the outlet bypass flow path 108.

The first release flow path 102 and the second release flow path 104 are provided with a dew-point instrument DP1 and a dew-point instrument DP2, respectively. The dew point is a temperature at which water vapor contained in hydrogen gas condenses when the hydrogen gas is cooled. The dew point is a physical quantity indicating the amount of moisture contained in the hydrogen gas, and the lower the dew point, the smaller the amount of moisture contained and the more dry the hydrogen gas. For the measurement of the dew point, for example, a well-known dew-point instrument (DP1 to DP4) of an electrostatic capacity type, a mirror surface cooling type, a crystal oscillation type, or the like is used. The outlet path 100 is provided with a dew-point instrument DP3 for measuring the dew point of the hydrogen gas flowing through the outlet path 100. The dew-point instrument DP3 measures the dew points of the hydrogen gas discharged from both the first release flow path 102 and the second release flow path 104.

### Operation of PSA Device

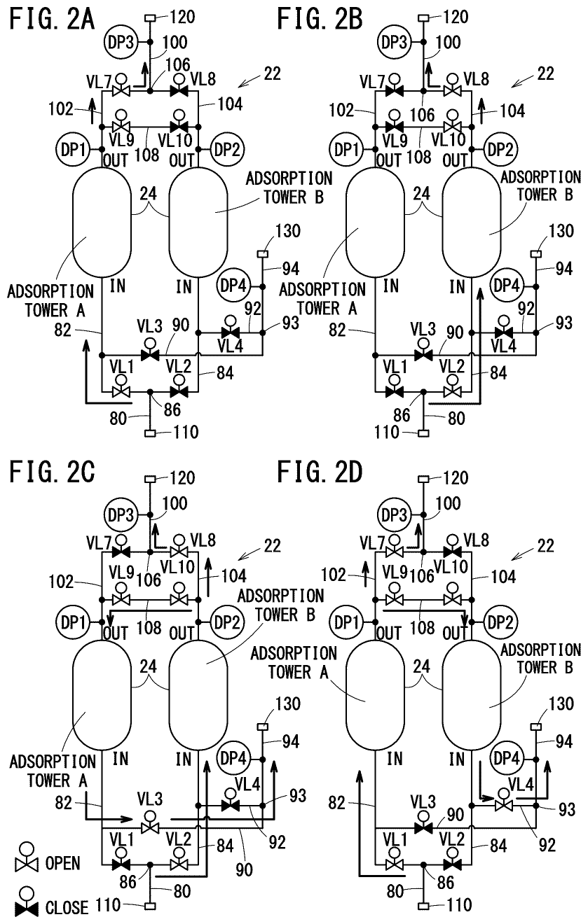

Next, the operation of the PSA device 22 according to the embodiment will be described with reference to FIGS. 2A to 2D. In the present embodiment, the PSA device 22 having two adsorption towers 24 will be described. However, even in the case of a device having three or more adsorption towers 24, the operation of alternately performing the adsorption process and the recovery process is the same as that of the present embodiment, and therefore, detailed description thereof is omitted.

FIG. 2A shows an adsorption process in which the hydrogen gas supplied from the hydrogen compression stack 16 is introduced into the hydrogen inlet 110 of the PSA device 22, is dehumidified by the adsorption tower A (processing adsorption tower), and is then output from the hydrogen outlet 120.

To be specific, the control device 30 opens VL1 and closes VL2, VL3, and VL4. Thus, the hydrogen gas introduced from the hydrogen compression stack 16 into the introduction path 80 through the hydrogen inlet 110 flows through the branch point 86 and the first supply flow path 82, and is supplied to the gas inlet of the adsorption tower A through the opening/closing valve VL1. The hydrogen gas supplied to the adsorption tower A is dehumidified by contacting the adsorbent contained in the adsorption tower A.

Further, the control device 30 opens VL7 and VL9 and closes VL8 and VL10. The dehumidified hydrogen gas (dry hydrogen gas) is discharged from the adsorption tower A through the gas outlet into the first release flow path 102, flows through the opening/closing valve VL7, the merging point 106 and the outlet path 100, and then discharged from the hydrogen outlet 120.

The first release flow path 102 and the outlet path 100 are provided with dew-point meters DP1 and DP3, respectively for measurement of the dew point of hydrogen gas flowing therethrough.

FIG. 2B shows an adsorption process in which the hydrogen gas supplied from the hydrogen compression stack 16 is introduced into the hydrogen inlet 110 of the PSA device 22, is dehumidified by the adsorption tower B (processing adsorption tower), and is then output from the hydrogen outlet 120. This is a state where the operation is switched to the adsorption tower B (recovering adsorption tower) after the adsorption amount of water in the adsorption tower A (processing adsorption tower) reaches the upper limit.

To be specific, the control device 30 opens VL2 and closes VL1, VL3, and VL4. Thus, the hydrogen gas introduced from the hydrogen compression stack 16 into the introduction path 80 through the hydrogen inlet 110 flows through the branch point 86 and the second supply flow path 84, and is supplied to the gas inlet of the adsorption tower B through the opening/closing valve VL2. The hydrogen gas supplied to the adsorption tower B is dehumidified by contacting the adsorbent contained in the adsorption tower B.

Further, the control device 30 opens VL8 and VL10 and closes VL7 and VL9. The dry hydrogen gas (dehumidified hydrogen gas) is discharged from the adsorption tower B through the gas outlet into the second release flow path 104, flows through the opening/closing valve VL8, the merging point 106 and the outlet path 100, and then is discharged from the hydrogen outlet 120.

The second release flow path 104 and the outlet path 100 are provided with a dew-point meter DP2 and the dew-point meter DP3, respectively for measurement of the dew point of hydrogen gas flowing therethrough.

FIG. 2C shows a recovery step in which the dehumidified hydrogen gas is supplied from the adsorption tower B (processing adsorption tower) to the adsorption tower A (recovering adsorption tower), and water contained in the adsorbent of the adsorption tower A is released for recovery of the adsorption tower A.

To be specific, the control device 30 opens VL2 and VL3 and closes VL1 and VL4. Thus, the hydrogen gas introduced from the hydrogen compression stack 16 into the introduction path 80 through the hydrogen inlet 110 is branched at the branch point 86, flows through the second supply flow path 84, and is supplied to the gas inlet of the adsorption tower B through the opening/closing valve VL2. The hydrogen gas supplied to the adsorption tower B is dehumidified by contacting the adsorbent contained in the adsorption tower B.

Further, the control device 30 opens VL8, VL9, and VL10, and closes VL7. Thus, the dehumidified hydrogen gas is supplied from the gas outlet of the adsorption tower B to the gas outlet of the adsorption tower A through the outlet bypass flow path 108. At the same time, the dehumidified hydrogen gas is discharged from the gas outlet of the adsorption tower B to the second release flow path 104, passes through the opening/closing valves VL8, flows through the merging point 106 and the outlet path 100, and is discharged from the hydrogen outlet 120. The hydrogen gas for recovery that has absorbed water released from the adsorbent of the adsorption tower A is discharged from the gas inlet of the adsorption tower A, and is led out to the outlet 130 dedicated to hydrogen for recovery through the first discharge flow path 90 dedicated to hydrogen for recovery. In this case, a throttle valve (not shown) may be provided in the outlet bypass flow path 108 to reduce the pressure of the hydrogen gas discharged from the adsorption tower B and supply the depressurized hydrogen gas to the adsorption tower A. This makes it possible to carry out recovery of the adsorption tower A more favorably.

FIG. 2D shows a recovery step in which the dehumidified hydrogen gas is supplied from the adsorption tower A (processing adsorption tower) to the adsorption tower B (recovery adsorption tower), and water contained in the adsorbent of the adsorption tower B is released for recovery of the adsorption tower B.

To be specific, the control device 30 opens VL1 and VL4 and closes VL2 and VL3. Thus, the hydrogen gas introduced from the hydrogen compression stack 16 into the introduction path 80 through the hydrogen inlet 110 flows through the branch point 86 and the first supply flow path 82, and is supplied to the gas inlet of the adsorption tower A through the opening/closing valve VL1. The hydrogen gas supplied to the adsorption tower A is dehumidified by contacting the adsorbent contained in the adsorption tower A.

Further, the control device 30 opens VL7, VL9, and VL10, and closes VL8. Thus, the dehumidified hydrogen gas is supplied from the gas outlet of the adsorption tower A to the gas outlet of the adsorption tower B through the outlet bypass flow path 108. At the same time, the dehumidified hydrogen gas is discharged from the gas outlet of the adsorption tower A to the first release flow path 102, passes through the opening/closing valves VL7, flows through the merging point 106 and the outlet path 100, and is discharged from the hydrogen outlet 120. The hydrogen gas for recovery that has absorbed water released from the adsorbent of the adsorption tower B is discharged from the gas inlet of the adsorption tower B, and is led out to the outlet 130 dedicated to hydrogen for recovery through the second discharge flow path 92 dedicated to hydrogen for recovery. In this case, a throttle valve (not shown) may be provided in the outlet bypass flow path 108 to reduce the pressure of the hydrogen gas discharged from the adsorption tower A and supply the depressurized hydrogen gas to the adsorption tower B. This makes it possible to carry out recovery of the adsorption tower B more favorably.

The control device 30 is constituted by an ECU (Electronic Control Unit). The ECU is composed of a computer having at least one processor (CPU), a memory, an input/output interface, and an electronic circuit. The at least one processor (CPU) executes a non-illustrated program (computer-executable instructions) that is stored in a memory. The control device 30 comprehensively carries out a control in relation to the electrochemical hydrogen compression system 10.

Concerning the operation of the electrochemical hydrogen compression system 10, a description thereof will be given with reference to FIG. 1.

The control device 30 opens the raw material hydrogen valve 52 provided in the raw material hydrogen supply path 50, and thereby supplies the raw material hydrogen to the hydrogen supply device 14. The amount of water contained in the raw material hydrogen that was supplied to the sealed container 44 of the hydrogen supply device 14 is adjusted, and then the raw material hydrogen is supplied as a hydrogen gas, via the hydrogen outlet 46 and the hydrogen supply flow path 60, to the hydrogen inlet PT1 of the hydrogen compression stack 16. Unused hydrogen gas that is discharged from the hydrogen outlet PT2 of the hydrogen compression stack 16 is circulated, via the hydrogen circulation flow path 62, to the hydrogen circulation inlet 67 of the sealed container 44. The control device 30 controls the speed of rotation of the circulation pump 66 provided in the hydrogen circulation flow path 62, and thereby adjusts the flow amount of the hydrogen gas circulated.

The hydrogen gas that is supplied to the hydrogen compression stack 16 is electrochemically compressed, and thereby becomes high pressure hydrogen gas, and the high pressure hydrogen gas is discharged from the high pressure hydrogen outlet PT3 to the high pressure hydrogen supply flow path 70. The high pressure hydrogen gas is supplied to the condenser 20 after the liquid water has been removed therefrom by the gas-liquid separator 18. The high pressure hydrogen gas, which has been dehumidified in the condenser 20, is supplied to the PSA device 22. Then, by having been further dehumidified in the PSA device 22, the dried high pressure hydrogen gas is supplied, via the high pressure hydrogen lead-out path 122, to the hydrogen tank 25 or the like.

### Flowchart of Electrochemical Hydrogen Compression System

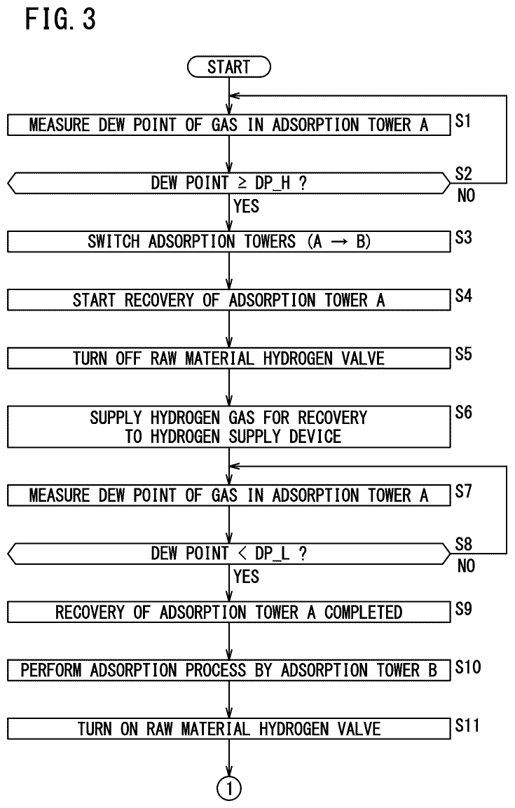

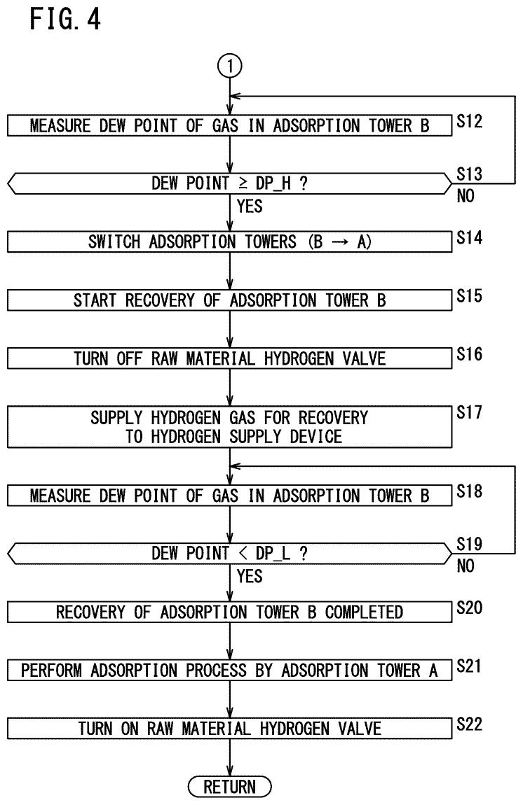

The operation procedure of the adsorption process and the recovery process of the electrochemical hydrogen compression system 10 according to the embodiment will be described based on the flowchart shown in FIGS. 3 and 4.

In step S1, the control device 30 measures the dew point of water contained in the hydrogen gas discharged in the adsorption process by the dew-point instrument DP1 provided in the first release flow path 102 of the adsorption tower A of the PSA device 22. The measured dew point is transmitted to the control device 30, and the control device 30 estimates the water contained in the adsorption tower A based on the dew point. In step S1, the PSA device 22 performs the adsorption process of FIG. 2A described above.

In step S2, the control device 30 determines whether or not the dew point measured by the dew-point instrument DP1 is equal to or greater than a predetermined value DP_H (dew-point upper limit value). In the case that the determination result is positive (step S2: YES), the control device 30 proceeds to step S3. In the case that the determination result is negative (step S2: NO), the control device 30 returns to step S1. The predetermined value DP_H is set based on the upper limit of the water that can be absorbed by the adsorbent filled in the adsorption tower 24. As the water content of the adsorbent increases, the amount of water that can be adsorbed decreases, and the dew point increases. The predetermined value DP_H corresponds to the dew point of the hydrogen gas that is to be released at the time when the water content of the adsorbent reaches the upper limit value.

In the present embodiment, the water content of the adsorbent is estimated from the dew point. However, the water content of the adsorbent may be estimated from the integrated flow rate of the hydrogen gas, the flow time of the hydrogen gas, the weight of the adsorption tower 24, and the like, instead of the dew point, and the corresponding predetermined values may be set. In the following description, physical quantities such as the integrated flow rate of hydrogen gas, the flow time of hydrogen gas, and the weight of the adsorption tower 24 may be used instead of the dew point.

In step S3, the control device 30 switches from the adsorption tower A to the adsorption tower B by controlling each of the opening/closing valves VL1 to VL10. Specifically, as described above, the control device 30 switches the adsorption tower A to the adsorption tower B by shifting the PSA device 22 from the state shown in FIG. 2A to the state shown in FIG. 2B.

In step S4, the control device 30 starts a recovery process for recovery of the adsorption tower A by controlling each of the opening/closing valves VL1 to VL10. Specifically, as described above, the control device 30 starts the recovery process of the adsorption tower A by shifting the PSA device 22 from the state shown in FIG. 2B to the state shown in FIG. 2C.

In step S5, the control device 30 closes (puts into the OFF state) the raw material hydrogen valve 52 provided in the raw material hydrogen supply path 50. Thus, the supply of the raw material hydrogen to the hydrogen supply device 14 is stopped.

In step S6, the control device 30 controls the pressure reducing valve 96 and the flow amount adjusting valve 98 to discharge the hydrogen gas used for recovery from the PSA device 22 through the outlet 130 dedicated to hydrogen for recovery and then supply the hydrogen gas used for recovery to the hydrogen supply device 14 via the return flow path 94. Next, the control device 30 supplies the hydrogen gas for recovery to the hydrogen compression stack 16 as hydrogen gas, and supplies the high-pressure hydrogen gas output from the hydrogen compression stack 16 to the adsorption tower B of the PSA device 22 via the gas-liquid separator 18 and the condenser 20.

In step S7, the control device 30 controls the dew-point instrument DP4 provided in the return flow path 94 to measure the dew point of the hydrogen gas used for recovery and discharged in the recovery process of the adsorption tower A.

In step S8, the control device 30 determines whether or not the dew point measured by the dew-point instrument DP4 is smaller than a predetermined value DP_L (dew-point lower threshold). In the case that the determination result is positive (step S8: YES), the control device 30 proceeds to step S9. In the case that the determination result is negative (step S8: NO), the control device 30 returns to step S7. Here, the predetermined value DP_L is set based on the water content of the adsorbent. When the dew point measured by the dew-point instrument DP4 decreases to a predetermined value DP_L in accordance with the decrease in the water content of the adsorbent, the control device 30 determines that water contained in the adsorbent has been sufficiently released, and the process transitions to step S9 to complete the recovery process of the adsorption tower A.

In step S10, the control device 30 starts the adsorption process by the adsorption tower B by controlling each of the opening/closing valves VL1 to VL10. Specifically, as described above, the control device 30 performs the adsorption process by the adsorption tower B by shifting the PSA device 22 from the state shown in FIG. 2C to the state shown in FIG. 2B.

In step S11, the control device 30 opens (puts into the ON state) the raw material hydrogen valve 52 provided in the raw material hydrogen supply path 50. Thus, the supply of the raw material hydrogen to the hydrogen supply device 14 is started.

In step S12, the control device 30 measures the dew point of water contained in the hydrogen gas discharged in the adsorption process by the dew-point instrument DP2 provided in the second release flow path 104 of the adsorption tower B of the PSA device 22. The measured dew point is transmitted to the control device 30, and the control device 30 estimates the water contained in the adsorption tower B based on the dew point. In step S12, the PSA device 22 performs the adsorption process of FIG. 2B described above.

In step S13, as in step S2, the control device 30 determines whether or not the dew point measured by the dew-point instrument DP2 is equal to or greater than a predetermined value DP_H (dew-point upper limit value). In the case that the determination result is positive (step S13: YES), the control device 30 proceeds to step S14. In the case that the determination result is negative (step S13: NO), the control device 30 returns to step S12. Here, the predetermined value DP_H is set in the same manner as in step S2.

The predetermined values (DP_H and DP_L) of the dew point may be set to different values between the adsorption tower A and the adsorption tower B. Further, even when physical quantities such as the integrated flow rate of hydrogen gas, the flow time of hydrogen gas, and the weight of the adsorption tower 24 are used instead of the dew point, different predetermined values (upper limit value and lower limit value) may be set for the adsorption tower A and the adsorption tower B.

In step S14, the control device 30 switches from the adsorption tower B to the adsorption tower A by controlling each of the opening/closing valves VL1 to VL10. Specifically, as described above, the control device 30 switches the adsorption tower B to the adsorption tower A by shifting the PSA device 22 from the state shown in FIG. 2B to the state shown in FIG. 2A.

In step S15, the control device 30 starts a recovery process for recovery of the adsorption tower B by controlling each of the opening/closing valves VL1 to VL10. Specifically, as described above, the control device 30 starts the recovery process of the adsorption tower B by shifting the PSA device 22 from the state shown in FIG. 2A to the state shown in FIG. 2D.

In step S16, the control device 30 closes the raw material hydrogen valve 52 provided in the raw material hydrogen supply path 50. Thus, the supply of the raw material hydrogen to the hydrogen supply device 14 is stopped.

In step S17, the control device 30 controls the pressure reducing valve 96 and the flow amount adjusting valve 98 to discharge the hydrogen gas, which is used for recovery, from the PSA device 22 through the outlet 130 dedicated to hydrogen for recovery, and then supply the hydrogen gas for recovery, to the hydrogen supply device 14 via the return flow path 94. Next, the control device 30 supplies the hydrogen gas for recovery to the hydrogen compression stack 16 as hydrogen gas, and supplies the high-pressure hydrogen gas output from the hydrogen compression stack 16 to the adsorption tower B of the PSA device 22 via the gas-liquid separator 18 and the condenser 20.

In step S18, the control device 30 controls the dew-point instrument DP4 provided in the return flow path 94 to measure the dew point of the hydrogen gas used for recovery and discharged in the recovery process of the adsorption tower B.

In step S19, the control device 30 determines whether or not the dew point measured by the dew-point instrument DP4 is smaller than a predetermined value DP_L (dew-point lower threshold). In the case that the determination result is positive (step S19: YES), the control device 30 proceeds to step S20. In the case that the determination result is negative (step S19: NO), the control device 30 returns to step S18. Here, the predetermined value DP_L is set in the same manner as in step S8. The control device 30 transitions to step S20 and completes the recovery process of the adsorption tower B.

In step S21, the control device 30 starts the adsorption process step by the adsorption tower A by controlling each of the opening/closing valves VL1 to VL10. Specifically, as described above, the control device 30 performs the adsorption process by the adsorption tower A by shifting the PSA device 22 from the state shown in FIG. 2D to the state shown in FIG. 2A.

In step S22, the control device 30 opens (puts into the ON state) the raw material hydrogen valve 52 provided in the raw material hydrogen supply path 50. Thus, the supply of the raw material hydrogen to the gas-liquid separator 18 is started.

### Timing Chart

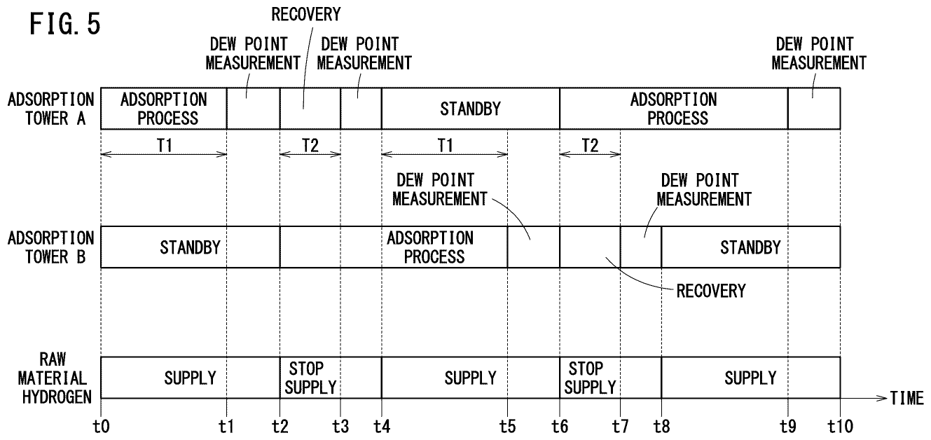

A timing chart relating to the adsorption tower A, the adsorption tower B, and the supply of the raw material hydrogen according to the present embodiment will be described with reference to FIG. 5. In such a timing chart, the adsorption process and the recovery process explained with reference to FIGS. 2A to 2D and the flowchart which is explained in FIGS. 3 and 4 are described on a time axis.

At time t0, the control device 30 causes the adsorption tower A to start the adsorption process. The adsorption tower A dehumidifies the hydrogen gas by removing water contained in the hydrogen gas and discharges the dried hydrogen gas. In the PSA device 22, the hydrogen gas flows as indicated by arrows in FIG. 2A. In this case, the control device 30 performs a standby step on the adsorption tower B, and no hydrogen gas is supplied to the adsorption tower B. The raw material hydrogen is supplied from the hydrogen supply device 14 to the hydrogen compression stack 16, and the compressed hydrogen gas is supplied to the adsorption tower A as the high-pressure hydrogen gas.

At time t1, the control device 30 starts a dew-point measurement step of measuring the dew point of the hydrogen gas by the dew-point instrument DP1 (step S1). Time t1 is set after a predetermined time period T1 has elapsed from time t0. The predetermined time period T1 is a time until the water content of the adsorbent contained in the adsorption tower A substantially approaches the upper limit value. The predetermined time period T1 is set in advance by experiments. The dew-point measurement step may be started at the same time as the adsorption process of the adsorption tower A is started, without waiting for the elapse of the predetermined time period T1.

At time t2, the control device 30 determines that the dew point measured by the dew-point instrument DP1 is larger than the predetermined value DP_H (step S2: YES). Next, the control device 30 switches from the adsorption tower A to the adsorption tower B (see step S3). That is, instead of the adsorption tower A, the adsorption tower B dehumidifies the hydrogen gas by removing water contained in the high-pressure hydrogen gas supplied from the hydrogen compression stack 16 and outputs the dried hydrogen gas. Inside the PSA device 22, the hydrogen gas flows as indicated by arrows in FIG. 2B.

After switching from the adsorption tower A to the adsorption tower B, the control device 30 starts the recovery process of the adsorption tower A (step S4). The dried hydrogen gas is supplied from the adsorption tower B to the adsorption tower A, and the adsorption tower A is subjected to recovery. In the PSA device 22, the hydrogen gas flows as indicated by arrows in FIG. 2C. In this case, the control device 30 stops the supply of the raw material hydrogen (step S5). The control device 30 controls in such a manner that the hydrogen gas for recovery discharged from the PSA device 22 is supplied to the hydrogen supply device 14. Then, by the control device 30, the hydrogen gas used for recovery is supplied to the hydrogen compression stack 16 as hydrogen gas, and the high-pressure hydrogen gas output from the hydrogen compression stack 16 is supplied to the adsorption tower B of the PSA device 22.

At time t3, the control device 30 starts a dew-point measurement step of measuring the dew point of the hydrogen gas by the dew-point instrument DP4 (step S7). Time t3 is set after a predetermined time period T2 has elapsed from time t2. The predetermined time period T2 is a time until the water content of the adsorbent contained in the adsorption tower A substantially approaches the lower threshold. The predetermined time period T2 is set in advance by experiments. The dew-point measurement step may be started at the same time as the recovery process of the adsorption tower A is started, without waiting for the elapse of the predetermined time period T2.

At time t4, in the case where the control device 30 determines that the dew point measured by the dew-point instrument DP3 is smaller than the predetermined value DP_L (step S8: YES), the recovery process of the adsorption tower A is completed (step S9). As a result, the supply of hydrogen gas from the adsorption tower B to the adsorption tower A is stopped. The control device 30 starts the adsorption step by the adsorption tower B (step S10). Inside the PSA device 22, the hydrogen gas flows as indicated by arrows in FIG. 2B. In this case, the control device 30 starts the supply of the raw material hydrogen (step S11). The raw material hydrogen gas thus supplied is further supplied to the hydrogen compression stack 16 as hydrogen gas after the water content is adjusted by the hydrogen supply device 14. The control device 30 supplies the high-pressure hydrogen gas compressed by the hydrogen compression stack 16 to the adsorption tower B. The adsorption tower A performs a standby step.

At time t5, the control device 30 starts the dew-point measurement process by the dew-point instrument DP2 (see step S12). Time t5 is set after a predetermined time period T1 has elapsed from time t4. The predetermined time period T1 is a time until the water content of the adsorbent contained in the adsorption tower B substantially approaches the upper limit value. The predetermined time period T1 is set in advance by experiments. The dew-point measurement step may be started at the same time as the adsorption process of the adsorption tower B is started, without waiting for the elapse of the predetermined time period T1.

At time t6, the control device 30 determines that the dew point measured by the dew-point instrument DP2 is larger than the predetermined value DP_H (step S13: YES). Next, the control device 30 switches from the adsorption tower B to the adsorption tower A (see step S14). That is, instead of the adsorption tower B, the adsorption tower A dehumidifies the hydrogen gas by removing water contained in the high-pressure hydrogen gas supplied from the hydrogen compression stack 16 and outputs the dried hydrogen gas. In the PSA device 22, the hydrogen gas flows as indicated by arrows in FIG. 2A.

After switching from the adsorption tower B to the adsorption tower A, the control device 30 starts the recovery process of the adsorption tower B (step S15). The dried hydrogen gas is supplied from the adsorption tower A to the adsorption tower B, and the adsorption tower B is subjected to recovery. In the PSA device 22, the hydrogen gas flows as indicated by arrows in FIG. 2D. In this case, the control device 30 stops the supply of the raw material hydrogen (step S16). The control device 30 controls in such a manner that the hydrogen gas used for recovery and discharged from the PSA device 22 is supplied to the hydrogen supply device 14. Then, by the control device 30, the hydrogen gas used for recovery is supplied to the hydrogen compression stack 16 as hydrogen gas, and the high-pressure hydrogen gas output from the hydrogen compression stack 16 is supplied to the adsorption tower A of the PSA device 22.

At time t7, the control device 30 starts a dew-point measurement step of measuring the dew point of the hydrogen gas by the dew-point instrument DP4 (step S18). Time t7 is set after a predetermined time period T2 has elapsed from time t6. The predetermined time period T2 is a time until the water content of the adsorbent contained in the adsorption tower B substantially approaches the lower threshold. The predetermined time period T2 is set in advance by experiments. The dew-point measurement step may be started at the same time as the recovery process of the adsorption tower B is started, without waiting for the elapse of the predetermined time period T2.

At time t8, in the case where the control device 30 determines that the dew point measured by the dew-point instrument DP4 is smaller than the predetermined value DP_L (step S19: YES), the recovery process of the adsorption tower B is completed (step S20). As a result, the supply of hydrogen gas from the adsorption tower A to the adsorption tower B is stopped. The control device 30 starts the adsorption process by the adsorption tower A (step S21). In the PSA device 22, the hydrogen gas flows as indicated by arrows in FIG. 2A. In this case, the control device 30 starts the supply of the raw material hydrogen (step S22). The raw material hydrogen gas is supplied to the hydrogen compression stack 16 as hydrogen gas after the water content is adjusted by the hydrogen supply device 14. The control device 30 supplies the high-pressure hydrogen gas compressed by the hydrogen compression stack 16 to the adsorption tower A.

The operation at time t9 is the same as the operation at time t1 (step S1), and the operation at time t10 is the same as the operation at time t2. Therefore, detailed descriptions of the operations at these and subsequent timings will be omitted.

The following supplementary notes are further disclosed in relation to the above embodiment.

### Supplementary Note 1

The electrochemical hydrogen compression system (10) according to the present disclosure includes: the hydrogen compression stack (16) having a unit cell (32) including the electrolyte membrane (34), the anode (36) disposed on one surface of the electrolyte membrane, the cathode (40) disposed on another surface of the electrolyte membrane, the compression stack being configured to be supplied with a hydrogen gas at the anode, and to deliver from the cathode a hydrogen gas which has been compressed; the electrical power source device (28) configured to apply a voltage to the hydrogen compression stack; the hydrogen supply device (14) configured to supply the hydrogen gas to the hydrogen compression stack via the hydrogen supply flow path (60); the pressure swing adsorption (PSA) device (22) including the plurality of adsorption towers (24) (adsorption tower A, adsorption tower B) configured to dehumidify the hydrogen gas which has been compressed by and discharged from the hydrogen compression stack; and the return flow path (94) configured to return the hydrogen gas which has been used for recovery of the adsorption towers to the hydrogen supply flow path connected to the hydrogen compression stack or to the hydrogen supply device.

Thus, the hydrogen gas used for recovery is returned to the hydrogen supply flow path connected to the hydrogen compression stack or the hydrogen supply device through the return flow path, and therefore the hydrogen gas is circulated and reused inside the electrochemical hydrogen compression system, and is not discharged to the outside. Accordingly, the efficiency with which the hydrogen gas is used is heightened, and a decrease in the hydrogen production efficiency of the electrochemical hydrogen compression system can be suppressed. Further, since the hydrogen gas used for recovery of the adsorption towers is not discharged to the outside, a special device is not required for the discharge, and the configuration of the electrochemical hydrogen compression system is simplified, which is economical.

### Supplementary Note 2

In the electrochemical hydrogen compression system according to Supplementary Note 1, the plurality of adsorption towers (adsorption tower A, adsorption tower B) may include the processing adsorption tower that is dehumidifying the hydrogen gas and the recovering adsorption tower that has adsorbed water and is releasing the water, and the adsorption towers may carry out recovery of the recovering adsorption tower by supplying from the processing adsorption tower to the recovering adsorption tower the hydrogen gas that has been dehumidified to cause the recovering adsorption tower to release water that the recovering adsorption tower has adsorbed and cause the recovering adsorption tower to recover.

Thus, recovery of the one adsorption tower in which the water content of the adsorbent has reached the upper limit can be carried out with the dry hydrogen gas discharged from the other adsorption tower included in the PSA device. Therefore, it is not necessary to provide a special device for recovery of the adsorption towers, and the configuration of the electrochemical hydrogen compression system is simplified and economical.

### Supplementary Note 3

In the electrochemical hydrogen compression system according to Supplementary Note 1, the hydrogen compression stack and the PSA device may be connected by the high pressure hydrogen supply flow path (70), and the gas-liquid separator (18) may be provided in the high pressure hydrogen supply flow path.

This makes it possible to separate and remove liquid water from the high-pressure hydrogen gas before being supplied to the PSA device. Therefore, the amount of water removed by the PSA device can be reduced, and the time until the water content of the adsorption tower reaches the upper limit value can be extended. Therefore, the operation rate of the adsorption tower is improved.

### Supplementary Note 4

In the electrochemical hydrogen compression system according to Supplementary Note 1, the return flow path may be provided with the pressure reducing valve (96) configured to reduce the pressure of the hydrogen gas for recovery flowing therethrough.

Thus, the pressure of the hydrogen gas for recovery supplied from the return flow path to the hydrogen compression stack via the hydrogen supply device can be adjusted, so that the hydrogen gas can be supplied to the hydrogen compression stack at an optimum pressure.

### Supplementary Note 5

In the electrochemical hydrogen compression system according to Supplementary Note 1, the return flow path may be provided with the flow amount adjusting valve (98) configured to adjust a flow amount of the hydrogen gas for recovery flowing therethrough, and the flow amount adjusting valve may adjust the flow amount of the hydrogen gas for recovery flowing therethrough based on an internal pressure of the sealed container (44) of the hydrogen supply device.

Thus, an appropriate amount of the hydrogen gas for recovery can be supplied to the hydrogen compression stack in accordance with the flow amount of the high-pressure hydrogen gas discharged from the hydrogen compression stack. Thus, the operation of the hydrogen compression stack can be optimized.

### Supplementary Note 6

In the electrochemical hydrogen compression system according to Supplementary Note 1, the hydrogen discharge hole provided at the downstream end of the return flow path may be opened in liquid water stored in the sealed container of the hydrogen supply device.

Thus, the liquid droplets contained in the hydrogen gas supplied from the return flow path can be removed, and the humidity of the hydrogen gas supplied to the hydrogen compression stack can be adjusted in a favorable manner by the liquid water.

### Supplementary Note 7

In the electrochemical hydrogen compression system according to Supplementary Note 2, in the case that the water content of the adsorbent of the recovering adsorption tower reaches the upper limit value, the hydrogen gas that has been dehumidified may be supplied from the processing adsorption tower to the recovering adsorption tower, and the recovery of the recovering adsorption tower may be started.

### Supplementary Note 8

In the electrochemical hydrogen compression system according to Supplementary Note 7, in the case that the water content of the adsorbent of the recovering adsorption tower is decreased to the predetermined value, supply of the hydrogen gas that has been dehumidified, from the processing adsorption tower to the recovering adsorption tower, may be stopped, and the recovery of the recovering adsorption tower may be completed.

### Supplementary Note 9

In the electrochemical hydrogen compression system according to Supplementary Note 5, the flow amount adjusting valve may be configured to adjust the flow amount of the hydrogen gas that has been used for recovery and flows through the return flow path in a manner so that a pressure in the space in the sealed container is maintained at the predetermined value.

Although concerning the present disclosure, a detailed description thereof has been presented above, the present disclosure is not necessarily limited to the individual embodiments described above. These embodiments can be subjected to various additions, substitutions, modifications, partial deletions and the like, within a range that does not depart from the essence and gist of the present disclosure, or alternatively, the spirit and gist of the present disclosure as derived from the contents described in the claims and their equivalents. Further, these embodiments can also be implemented in combination. For example, in the above-described embodiments, the order of each of the operations and the order of each of the processes are illustrated as examples, and the present invention is not necessarily limited to these features.

1. An electrochemical hydrogen compression system, comprising:
a hydrogen compression stack having a unit cell including an electrolyte membrane, an anode disposed on one surface of the electrolyte membrane, and a cathode disposed on another surface of the electrolyte membrane, the hydrogen compression stack being configured to be supplied with a hydrogen gas at the anode, and to discharge from the cathode the hydrogen gas which has been compressed;
an electrical power source device configured to apply a voltage to the hydrogen compression stack;
a hydrogen supply device configured to supply the hydrogen gas to the hydrogen compression stack via a hydrogen supply flow path;
a pressure swing adsorption device including a plurality of adsorption towers configured to dehumidify the hydrogen gas which has been compressed by and discharged from the hydrogen compression stack; and
a return flow path configured to return the hydrogen gas which has been used for recovery of the adsorption towers to the hydrogen supply flow path of the hydrogen compression stack or to the hydrogen supply device.

2. The electrochemical hydrogen compression system according to claim 1, wherein
the plurality of adsorption towers include a processing adsorption tower that is dehumidifying the hydrogen gas and a recovering adsorption tower that has adsorbed water and is releasing the water, and
the plurality of adsorption towers carry out recovery of the recovering adsorption tower by supplying from the processing adsorption tower to the recovering adsorption tower the hydrogen gas that has been dehumidified to cause the recovering adsorption tower to release the water that the recovering adsorption tower has adsorbed and cause the recovering adsorption tower to recover.

3. The electrochemical hydrogen compression system according to claim 1, wherein the hydrogen compression stack and the pressure swing adsorption device are connected by a high-pressure hydrogen supply flow path, and a gas-liquid separator is provided in the high-pressure hydrogen supply flow path.

4. The electrochemical hydrogen compression system according to claim 1, wherein the return flow path is provided with a pressure reducing valve configured to reduce a pressure of the hydrogen gas that has been used for recovery and flows through the return flow path.

5. The electrochemical hydrogen compression system according to claim 1, wherein
the return flow path is provided with a flow amount adjusting valve configured to adjust a flow amount of the hydrogen gas that has been used for recovery and flows through the return flow path, and
based on an internal pressure of a sealed container of the hydrogen supply device, the flow amount adjusting valve is configured to adjust the flow amount of the hydrogen gas that has been used for recovery and flows through the return flow path.

6. The electrochemical hydrogen compression system according to claim 1, wherein a hydrogen discharge hole provided at a downstream end of the return flow path is opened in liquid water stored in a sealed container of the hydrogen supply device.

7. The electrochemical hydrogen compression system according to claim 2, wherein in a case that a water content of an adsorbent of the recovering adsorption tower reaches an upper limit value, the hydrogen gas that has been dehumidified is supplied from the processing adsorption tower to the recovering adsorption tower, and the recovery of the recovering adsorption tower is started.

8. The electrochemical hydrogen compression system according to claim 7, wherein in a case that the water content of the adsorbent of the recovering adsorption tower is decreased to a predetermined value, supply of the hydrogen gas that has been dehumidified, from the processing adsorption tower to the recovering adsorption tower, is stopped, and the recovery of the recovering adsorption tower is completed.

9. The electrochemical hydrogen compression system according to claim 5, wherein the flow amount adjusting valve is configured to adjust the flow amount of the hydrogen gas that has been used for recovery and flows through the return flow path in a manner so that a pressure in a space in the sealed container is maintained at a predetermined value.
